(19) United States
(12) Patent Application Publication
(10) Pub. No.: US 2006/0127711 A1
(43) Pub. Date: Jun. 15, 2006

(54) Systems and methods for fuel cartridge distribution

(75) Inventors: James L. Kaschmitter, Pleasanton, CA (US); Ian W. Kaye, Livermore, CA (US); Robert David Richardson, Danville, CA (US); William R. Di Scipio, Fremont, CA (US)

Correspondence Address: BEYER WEAVER & THOMAS LLP, P.O. BOX 70250, OAKLAND, CA, 94612-0250, US

(73) Assignee: UltraCell Corporation, a California Corporation, Livermore, CA (US)

(21) Appl. No.: 11/316,199

(22) Filed: Dec. 21, 2005

Related U.S. Application Data
(63) Continuation-in-part of application No. 10/877,766, filed on Jun. 25, 2004.
(60) Provisional application No. 60/638,421, filed on Dec. 21, 2004.
(60) Provisional application No. 60/677,424, filed on May 2, 2005.
(60) Provisional application No. 60/682,598, filed on May 18, 2005.

(51) Int. Cl. H01M 8/04

(52) U.S. Cl. 429/13; 429/22

(57) ABSTRACT

The invention relates to systems and methods that improve distribution of fuel cartridges. The cartridges include compatibility information. A controller on the device validates the compatibility information before permitting fuel provision from the cartridge to the device. Invalid compatibility information, or absence of the compatibility information, then denies fuel flow to the device. This permits the device to validate that the cartridge and its contents are acceptable. This improves distribution by allowing the device or fuel cell manufacturer to implement cartridge selectivity by permitting cartridges from select manufacturers to provide fuel and denying cartridge of other manufacturers from providing fuel. Compatibility information stored in the cartridge memory may also be encrypted to prevent open access to the compatibility information. The compatibility information also improves fuel refilling distribution. In this case, the compatibility information permits a cartridge or device manufacturer to selectively control who can refill their cartridges.

### CROSS-REFERENCE TO RELATED APPLICATIONS

This application a) claims priority under 35 U.S.C. §119(e) to: i) U.S. Provisional Patent Application No. 60/638,421 filed on Dec. 21, 2004 entitled “Micro Fuel Cell Architecture”, ii) U.S. Provisional Patent Application No. 60/677,424 filed on May 2, 2005 entitled “Micro Fuel Cell Fuel Cartridge Apparatus”, and iii) U.S. Provisional Patent Application No. 60/682,598 filed on May 18, 2005 entitled “Fuel Storage Devices for Use with Micro Fuel Cells”; and

b) claims priority under 35 U.S.C. §120 to commonly owned and co-pending U.S. patent application Ser. No. 10/877,766, filed Jun. 25, 2004 and entitled “PORTABLE FUEL CARTRIDGE FOR FUEL CELLS”, which claimed priority under 35 U.S.C. §119(e) from i) U.S. Provisional Patent Application No. 60/482,996 filed on Jun. 27, 2003, ii) U.S. Provisional Patent Application No. 60/483,416 and filed on Jun. 27, 2003, and iii) U.S. Provisional Patent Application No. 60/483,415 and filed on Jun. 27, 2003; each of these patent applications provided above is incorporated by reference for all purposes.

### BACKGROUND OF THE INVENTION

The present invention relates to fuel cell technology. In particular, the invention relates to portable fuel cartridges that store a fuel for use in a fuel cell system, distribution of fuel cartridges, refilling of fuel cartridges, and techniques to permit regulation of which devices can draw fuel from a cartridge.

A fuel cell electrochemically combines hydrogen and oxygen to produce electricity. The ambient air readily supplies oxygen; hydrogen provision, however, calls for a working supply. The hydrogen supply may include a direct hydrogen supply or a ‘reformed’ hydrogen supply. A direct hydrogen supply outputs hydrogen, such as compressed hydrogen in a pressurized container or a solid-hydrogen storage system.

A reformed hydrogen supply processes a fuel (or ‘fuel source’) to produce hydrogen. The fuel acts as a hydrogen carrier, is manipulated to separate hydrogen, and may include a hydrocarbon fuel, hydrogen bearing fuel stream, or any other hydrogen bearing fuel such as ammonia. Currently available hydrocarbon fuels include methanol, ethanol, gasoline, propane and natural gas. Liquid fuels offer high energy densities and the ability to be readily stored and transported.

Consumer electronics devices and other portable electrical power applications currently rely on lithium ion and other battery technologies. Portable fuel cell systems that generate electrical energy for portable applications such as electronics devices would be desirable, but are not yet commercially available. Distribution of portable fuel cartridges that transport the fuel is also needed before commercial adoptance of portable fuel cell systems becomes widespread.

### SUMMARY OF THE INVENTION

The present invention relates to systems and methods that improve distribution of fuel cartridges which store fuel for provision to a device that includes a fuel cell or fuel cell system. Distribution is improved by including compatibility information with a cartridge. A controller on the device validates the compatibility information before permitting fuel provision from the cartridge to the device. This permits the device to validate that the cartridge and its contents are acceptable.

In addition, the present invention allows the device or fuel cell manufacturer to implement cartridge selectivity. For example, the compatibility information allows a manufacturer to permit fuel flow from cartridges having a correct fuel or fuel mixture, or permit fuel flow from cartridges produced by a select set of cartridge suppliers while denying fuel flow from unauthorized cartridge suppliers.

Compatibility information stored in the cartridge memory may also be encrypted to prevent open access to the compatibility information.

The compatibility information also improves fuel refilling distribution. In this case, the compatibility information permits a cartridge or device manufacturer to selectively control who can refill their fuel cartridges.

In one aspect, the present invention relates to a method for validating fuel provision from a cartridge that stores a fuel. The method includes reading compatibility information from a memory included with the cartridge. The method also includes validating the compatibility information before permitting fuel provision from the cartridge to the device. The method further includes permitting fuel to flow from the cartridge to the device when the compatibility information is valid, or denying fuel to flow from the cartridge to the device when the compatibility information is not valid or absent.

In another aspect, the present invention relates to a device for receiving fuel from a cartridge that stores a fuel for use in a fuel cell system. The device includes a fuel cell and a controller. The controller operates according to instructions stored in a device memory, and is configured to communicate with a memory on the cartridge, obtain compatibility information from the cartridge memory, and validate the compatibility information before permitting fuel provision from the cartridge to the device.

In yet another aspect, the present invention relates to a fuel cell system for producing electrical energy. The fuel cell system includes a portable cartridge for storing a fuel and a device that couples to the cartridge. The cartridge includes a memory that stores compatibility information and a cartridge connector. The device includes a fuel cell, a mating connector that interfaces with the cartridge connector to permit transfer of the fuel from the cartridge to the device, and a controller. The controller communicates with the cartridge memory, obtains compatibility information from the cartridge memory, and validates the compatibility information before permitting fuel provision from the cartridge to the device.

In still another aspect, the present invention relates to a method of distributing cartridges for use with a device that includes a fuel cell. The method includes storing a fuel in each of the cartridges. The method also includes adding compatibility information to a memory included in each of the cartridges. The compatibility information enables the device to validate the compatibility information before permitting fuel provision from a cartridge coupled to the device. The method also includes distributing the cartridges for sale to consumers.

In another aspect, the present invention relates to a a method for storing a fuel in a fuel cartridge for use with a fuel cell system. The method includes at least partially removing a gas from the liquid fuel. The method also includes at least partially removing a gas from a volume in the fuel cartridge that stores the fuel before fuel is stored in the cartridge. The method further includes storing the liquid fuel in the volume.

These and other features of the present invention will be described in the following description of the invention and associated figures.

### BRIEF DESCRIPTION OF THE DRAWINGS

FIG. 1 illustrates a distribution system and accordance with one embodiment of present invention.

FIG. 2 illustrates an exemplary RMFC fuel cell system for producing electrical energy in accordance with one embodiment of the present invention.

FIG. 3A shows a simplified cross section of a cartridge in accordance with one embodiment of the present invention.

FIG. 3B illustrates a cartridge in accordance with another embodiment of the present invention.

FIG. 4 shows a method for validating fuel provision from a cartridge that stores a fuel in accordance with one embodiment of present invention.

FIG. 5 shows a method for cartridge distribution that applies cartridge/device validation in accordance with one embodiment of present invention.

FIG. 6 shows a process flow for storing fuel in a portable fuel cartridge in accordance with one embodiment of the present invention.

FIG. 7 shows a process flow for storing fuel in a portable fuel cartridge in accordance with one embodiment of the present invention.

### DETAILED DESCRIPTION OF THE PREFERRED EMBODIMENTS

The present invention is described in detail with reference to a few preferred embodiments as illustrated in the accompanying drawings. In the following description, numerous specific details are set forth in order to provide a thorough understanding of the present invention. It will be apparent, however, to one skilled in the art, that the present invention may be practiced without some or all of these specific details. In other instances, well known process steps and/or structures have not been described in detail in order to not unnecessarily obscure the present invention.

### Cartridge Distribution

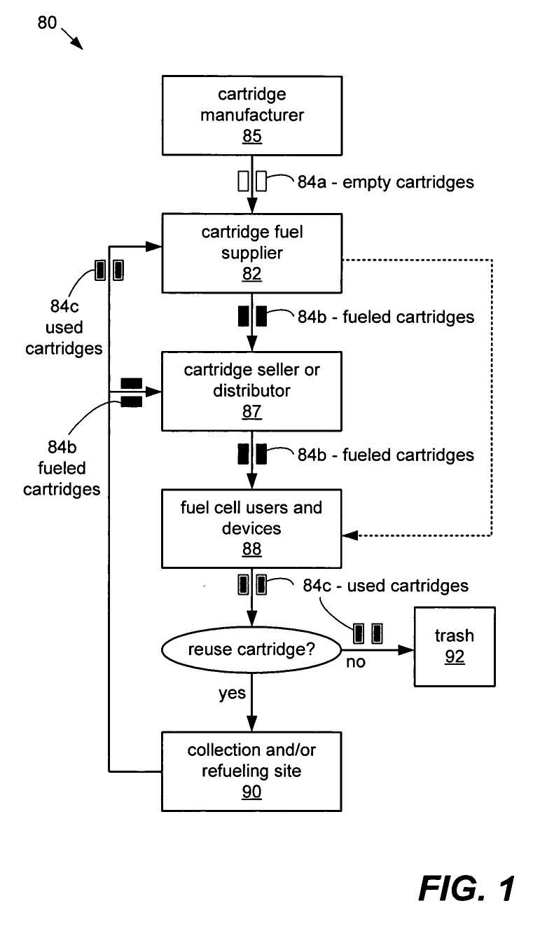

The present invention improves distribution of fuel cartridges that store fuel for use with a device that includes a fuel cell or fuel cell system. FIG. 1 illustrates a simplified distribution system 80 in accordance with one embodiment of present invention.

A cartridge supplier 82 loads fuel into cartridges 84. In one embodiment, cartridge supplier 82 does not manufacture cartridges 84 and obtains them from a cartridge manufacturer 85. Manufacturer 85 may purchase cartridge components from multiple cartridge component vendors and assemble the cartridges 84. This supply option becomes more attractive as the number of components in the cartridges 84 increasingly uses commercially available components, such as one or more commercially available components described below. Outsourcing the commercially available components removes the need for supplier 82 or manufacturer 85 to actually manufacture every components in the cartridges 84. Alternatively, supplier 82 may be responsible for both manufacture and assembly of cartridges 84, as well as loading fuel into the cartridges.

In general, supplier 82 refers to any organization that stores fuel in a fuel cartridge for use with a fuel cell system and/or any organization that distributes cartridges 84. Exemplary suppliers 82 include fuel cell manufacturers, businesses specializing in fuel cartridge sales and distribution, electronics device manufacturers such as laptop manufacturers and distributors, retail outlets, consumer electronics outlets, airport kiosks and online retailers, etc. A supplier 82 may also distribute cartridges 84 via mail services.

Fuel cell users then purchase or otherwise obtain cartridges 84 for use with their fuel-cell devices 88. When finished with the cartridge, user may then dispose of the cartridge 84 in trash or recycling 92. This is likely when the cartridge is intended for disposable use, or the user does not want to refill the cartridge (e.g., it is broken or they no longer need a fuel-cell cartridge). It is understood that a used cartridge 84 may not be fully depleted before disposal or refilling.

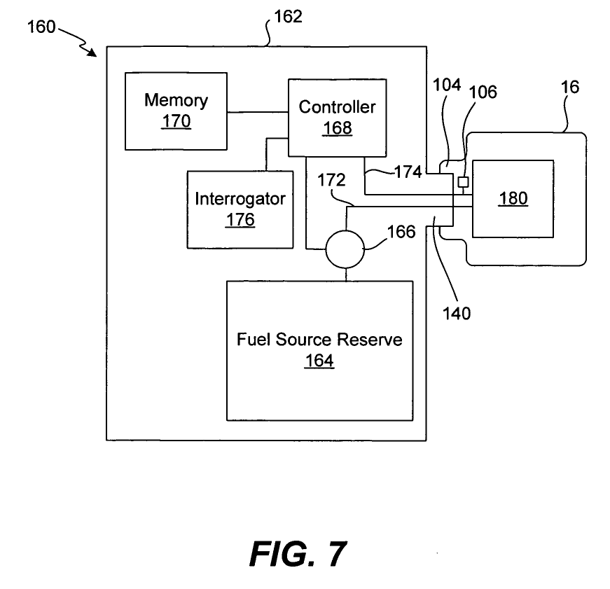

Users that want to refill a cartridge bring it to a collection site 90. The collection site 90 provides a service that accepts used cartridges 84 and provides them back to cartridge fuel supplier 82. This may be one for a fee, free of charge, or with a credit paid to the user. The credit may include cash and/or credit towards the purchase of a new cartridge. In another embodiment, collection site 90 also doubles as a cartridge fuel supplier 82. In this case, site 90 includes refueling capabilities that store fuel into a portable fuel cartridge 84 (FIG. 7). For example, site 90 may include a semi-portable refilling station configured to refill portable fuel cartridges 84. Collection site 90 refers to any business or organization that receives fuel cartridges 84 from users. Exemplary collection sites 90 may include retail stores and organizations, electronics stores, fuel cell manufacturers, businesses specializing in fuel cartridges sales and distributions, airport kiosks and office supply outlets, etc. A collection site 90 may also receive cartridges 84 using mail services. Other collection sites are suitable for use. Fueled cartridges can then be returned to sales 87.

Cartridges collected for external refilling and then provided to cartridge fuel supplier 82. Upon receipt, supplier 82 refills the cartridge and may perform one or more additional distribution tasks including: checking the health of a cartridge 84, updating any security information on a cartridge such as updating encryption and digital handshake information stored on a chip included with the cartridge 84, verifying the cartridge serial number, resetting the fuel level memory, checking for leaks, updating a cartridge database, and visual inspection, for example.

Distribution system 80 is not geographically limited to any particular region or country. Thus, a global distribution system 80 may include cartridge manufacturers 85 and fuel suppliers 82 that are located in multiple countries. Similarly, users and their devices 88 may be in multiple countries, and in some cases, a single user alone use a cartridge 84 in multiple countries (e.g., they use a cartridge on an international airline flight). Thus, the present invention contemplates that a cartridge manufactured or sold in one country may readily appear and be used in another country, whether intended by a manufacturer or supplier or not.

### Fuel Cell Systems

Cartridges distributed by the present invention are suitable for use with a wide array of fuel cell systems. A micro fuel cell system generates dc voltage, and may be used in numerous portable applications. For example, electrical energy generated by a micro fuel cell may power a notebook computer, or power a portable electrical generator carried by military personnel. In one embodiment, the present invention provides ‘small’ fuel cells that are configured to output less than 200 watts of power (net or total). Fuel cells of this size are also referred to as ‘micro fuel cells’. In one embodiment, the fuel cell is configured to controllably generate and output from about 1 milliwatt to about 200 Watts. In another embodiment, the fuel cell generates from about 5 Watts to about 60 Watts. One specific portable fuel cell package produces about 20 Watts or about 45 Watts, depending on the number of cells in the stack.

Cartridges of the present invention are also suitable for use with a variety of fuel cell systems types. Suitable system architectures include direct methanol fuel cell (DMFC) systems, reformed methanol fuel cell (RMFC) systems, solid oxide fuel cell (SOF) systems, sodium borohydride fuel cell systems, formic acid and reformed diesel PEM systems etc. All these fuel cell system types rely on a fuel cartridge for fuel storage and transportation.

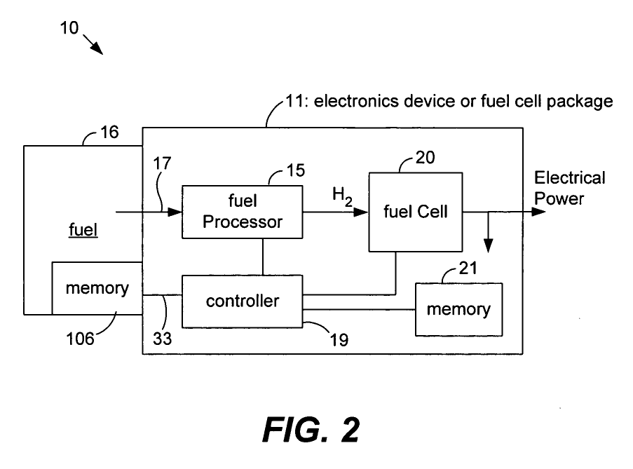

FIG. 2 illustrates an RMFC fuel cell system 10 for producing electrical energy in accordance with one embodiment of the present invention. Fuel cell system 10 includes a cartridge 16 that provides fuel 17 to a fuel cell device 11. Device 11 includes a fuel processor 15, a fuel cell 20 and a controller 19. Fuel processor 15 processes a fuel 17 to produce hydrogen for supply to fuel cell 20. Fuel cell system 10 may be a stand-alone system, which is a single package or device 11 that produces power as long as it has access to a) oxygen and b) hydrogen or a hydrogen source such as fuel 17.

Cartridge 16, which is also interchangeably referred to as a ‘storage device’, stores a fuel 17. Cartridge 16 may comprise a refillable and/or disposable fuel cartridge; either design permits recharging capability for system 10 or an electronics device 11 by swapping a depleted cartridge 16 for one with fuel. A connector on cartridge 16 interfaces with a mating connector on electronics device 11 to permit fuel to be withdrawn from cartridge 16. In one embodiment, cartridge connector includes a contact valve that interfaces with mating plumbing on the device 11. When depressed, the contact valve provides fluidic communication to fuel 17 within cartridge 16.

Cartridge 16 includes an internal cavity adapted to contain the fuel. In one embodiment, cartridge 16 includes a bladder, in the internal cavity, that contains the fuel and conforms to the volume of fuel 17 in the bladder. An outer rigid housing or housing assembly provides mechanical protection for the bladder. The bladder and housing permit a wide range of portable and non-portable cartridge sizes with fuel capacities ranging from a few milliliters to several liters. In another embodiment, the cartridge is vented and includes a small hole, single direction flow valve, hydrophobic filter, or other aperture to allow air to a) enter the fuel cartridge as fuel 17 is consumed and displaced from the cartridge, and b) exit the cartridge housing as fuel is loaded into the cartridge during initial filling or subsequent refilling. This type of cartridge allows for “orientation” independent operation since pressure in the bladder remains relatively constant as fuel is displaced.

A pressure source moves the fuel 17 from cartridge 16 to fuel processor 15. In one embodiment, a pump in device 11 draws and controls fuel 17 flow from cartridge 16, such as a diaphragm pump. Cartridge 16 may also be pressurized with a pressure source such as foam or a propellant internal to the housing that pushes on the bladder (e.g, propane, compressed nitrogen gas or compressed oxygen from the system 10). In this case, system 10 then employs a control valve to regulate flow, etc. If system 10 is load following, then a control system meters fuel 17 flow to deliver fuel to processor 15 at a flow rate determined by a required power level output of fuel cell 20 and regulates a controlled item (e.g., the pump or valve) accordingly. Other pressure sources may be used to move fuel 17 from cartridge 16. For example, some cartridge designs suitable for use herein include a wick that moves a liquid fuel from locations within a fuel cartridge to a cartridge exit.

Fuel 17 acts as a carrier for hydrogen and can be processed or manipulated to separate hydrogen. As the terms are used herein, ‘fuel’, ‘fuel source’ and ‘hydrogen fuel source’ are interchangeable and all refer to any fluid (liquid or gas) that can be manipulated to separate hydrogen. Fuel 17 may include any hydrogen bearing fuel stream, hydrocarbon fuel or other source of hydrogen such as ammonia. Currently available hydrocarbon fuels 17 suitable for use with the present invention include gasoline, C₁ to C₄ hydrocarbons, their oxygenated analogues and/or their combinations, for example. Other fuel sources may be used with a fuel cell package of the present invention, such as sodium borohydride. Several hydrocarbon and ammonia products may also be used. Liquid fuels 17 offer high energy densities and the ability to be readily stored and shipped.

Fuel 17 may be stored as a fuel mixture. When the fuel processor 15 comprises a steam reformer, for example, storage device 16 includes a fuel mixture of a hydrocarbon fuel and water. Hydrocarbon fuel/water mixtures are frequently represented as a percentage of fuel in water. In one embodiment, fuel 17 comprises methanol or ethanol concentrations in water in the range of 1-99.9%. Other liquid fuels such as butane, propane, gasoline, military grade “JP8”, etc. may also be contained in storage device 16 with concentrations in water from 5-100%. In a specific embodiment, fuel 17 comprises 67% methanol by volume.

Cartridge 16 mechanically and detachably couples to device 11, which includes fuel processor 15 and fuel cell 20. In one embodiment, device 11 is a portable package that includes a fuel cell system and one or more DC outputs. Such a portable package operates as an independent and portable power source that provides electrical energy as long as the package has access to fuel 17 and oxygen. Military personnel, who carry an array of electronics devices and perform extended operations, benefit from such a portable and replenishable power supply. In another embodiment, device 11 includes an electronics device that consumes electrical energy generated by fuel cell 20. Examples include laptop computers, handheld computers and PDAs, cell phones, lights such as flashlights, radios, etc. Device 11 may export the energy to another electronics device, use it internally, and combinations thereof, as determined by controller 19. Fuel cells described herein are useful to power a wide array of electronics devices, and in general, the present invention is not limited by what device couples to cartridge 16 or receives fuel from cartridge 16.

In one embodiment, the present invention uses a number of techniques to ensure compatibility between cartridge 16 and device 11. In a specific embodiment, device 11 implements a digital validation and authentication of cartridge 16 and compatibility information stored in a memory 106 included with the cartridge. As will be described in further detail below, the digital validation and authentication ensures that cartridge 16 a suitable for use with device 11 (e.g., it has the right fuel or was produced by a quality-ensuring manufacturer). The validation handshake may rely on encryption and other security features in cartridge 16 and/or device 11. A successful validation between device 11 and cartridge 16 permits fuel to flow from the cartridge to the device.

System 10 includes controller 19 in device 11 and memory 106 with cartridge 16. In this case, cartridge 16 is considered ‘smart’ since memory 106 stores information related to usage of cartridge 16. Controller 19 regulates fuel cell system 10 and performs a number of functions based on instructions stored in memory 21. These functions may include: power regulation of electrical energy produced by fuel cell 20, regulation of fuel 17 flow from cartridge 16 to fuel processor 15 and within system 10, control of fuel processor 15 components, control fuel cell 20 components, and thermal management (e.g., fans or heating systems) for system 10.

In addition, controller 19, operating according to instructions stored as software in memory 21, is configured to communicate with memory 106. More specifically, controller 19 is configured to read compatibility information from memory 21 and validate the compatibility information and/or cartridge 16 before permitting fuel provision from cartridge 16 to device 11. Controller 19 may also send out the signal to initiate fuel flow. As shown, a link 33 permits communication of control signals and information between controller 19 and memory 106, and also permits controller 19 to read and write to memory 106. Compatibility validation between device 11 and cartridge, security authentication and other forms of interaction between controller 19 and memory 106 are described in further detail below.

Compatibility validation and authentication as described herein will typically be implemented by a suitable processor or computer-based apparatus. This may include a central processing unit (CPU), read only memory (ROM), random access memory (RAM), and nonvolatile memory such as flash memory. Controller 19 may include a commercially available processor, such as one of the family of Motorola or Intel processors. Device memory 21 includes one or more memories or memory modules configured to store program instructions for validating cartridges and compatibility information provided with cartridges and other functions of the present invention described herein. Such memory or memories may also be configured to store data structures, cartridge usage history data, cartridge and/or manufacturing data, refilling data, or other specific non-program information described herein.

Because such information and program instructions may be employed to implement the systems/methods described herein, the present invention relates to machine-readable media that include program instructions, state information, etc. for performing various operations described herein. Examples of machine-readable media include, but are not limited to, magnetic media such as hard disks, floppy disks, and magnetic tape; optical media such as CD-ROM disks; magneto-optical media such as floptical disks; and hardware devices that are specially configured to store and perform program instructions, such as read-only memory devices (ROM) and random access memory (RAM). Examples of program instructions include both machine code, such as produced by a compiler, and files containing higher level code that may be executed by the computer using an interpreter.

Fuel processor 15 processes fuel 17 and outputs hydrogen. In one embodiment, a hydrocarbon fuel processor 15 heats and processes a hydrocarbon fuel 17 in the presence of a catalyst to produce hydrogen. Fuel processor 15 comprises a reformer, which is a catalytic device that converts a liquid or gaseous hydrocarbon fuel 17 into hydrogen and carbon dioxide. As the term is used herein, reforming refers to the process of producing hydrogen from a fuel 17. Fuel processor 15 may output either pure hydrogen or a hydrogen bearing gas stream (also commonly referred to as ‘reformate’).

Various types of reformers are suitable for use in fuel cell system 10; these include steam reformers, auto thermal reformers (ATR) and catalytic partial oxidizers (CPOX) for example. A steam reformer only needs steam and fuel to produce hydrogen. ATR and CPOX reformers mix air with a fuel/steam mixture. ATR and CPOX systems reform fuels such as methanol, diesel, regular unleaded gasoline and other hydrocarbons. In a specific embodiment, storage device 16 provides methanol 17 to fuel processor 15, which reforms the methanol at about 280° C. or less and allows fuel cell system 10 usage in low temperature applications.

Fuel cell 20 electrochemically converts hydrogen and oxygen to water, generating electrical energy (and sometimes heat) in the process. Ambient air readily supplies oxygen. A pure or direct oxygen source may also be used. The water often forms as a vapor, depending on the temperature of fuel cell 20. For some fuel cells, the electrochemical reaction may also produce carbon dioxide as a byproduct.

In one embodiment, fuel cell 20 is a low volume ion conductive membrane (PEM) fuel cell suitable for use with portable applications such as consumer electronics. A PEM fuel cell comprises a membrane electrode assembly (MEA) that carries out the electrical energy generating an electrochemical reaction. The MEA includes a hydrogen catalyst, an oxygen catalyst, and an ion conductive membrane that a) selectively conducts protons and b) electrically isolates the hydrogen catalyst from the oxygen catalyst. A hydrogen gas distribution layer may also be included; it contains the hydrogen catalyst and allows the diffusion of hydrogen therethrough. An oxygen gas distribution layer contains the oxygen catalyst and allows the diffusion of oxygen and hydrogen protons therethrough. Typically, the ion conductive membrane separates the hydrogen and oxygen gas distribution layers. In chemical terms, the anode comprises the hydrogen gas distribution layer and hydrogen catalyst, while the cathode comprises the oxygen gas distribution layer and oxygen catalyst.

In one embodiment, a PEM fuel cell includes a fuel cell stack having a set of bi-polar plates. In one embodiment, each bi-polar plate is formed from a single sheet of metal that includes channel fields on opposite surfaces of the metal sheet. The single bi-polar plate thus dually distributes hydrogen and oxygen: one channel field distributes hydrogen while a channel field on the opposite surface distributes oxygen. In another embodiment, each bi-polar plate is formed from multiple layers that include more than one sheet of metal. Multiple bi-polar plates are stacked to produce the ‘fuel cell stack’ in which a membrane electrode assembly is disposed between each pair of adjacent bi-polar plates. Gaseous hydrogen distribution to the hydrogen gas distribution layer in the MEA occurs via a channel field on one plate while oxygen distribution to the oxygen gas distribution layer in the MES occurs via a channel field on a second plate on the other surface of the membrane electrode assembly.

In electrical terms, the anode includes the hydrogen gas distribution layer, hydrogen catalyst and a bi-polar plate. The anode acts as the negative electrode for fuel cell 20 and conducts electrons that are freed from hydrogen molecules so that they can be used externally, e.g., to power an external circuit or stored in a battery. In electrical terms, the cathode includes the oxygen gas distribution layer, oxygen catalyst and an adjacent bi-polar plate. The cathode represents the positive electrode for fuel cell 20 and conducts the electrons (in PEM fuel cells) back from the external electrical circuit to the oxygen catalyst, where they can recombine with hydrogen ions and oxygen to form water.

In a fuel cell stack, the assembled bi-polar plates are connected in series to add electrical potential gained in each layer of the stack. The term ‘bi-polar’ refers electrically to a bi-polar plate (whether mechanically comprised of one plate or two plates) sandwiched between two membrane electrode assembly layers. In a stack where plates are connected in series, a bi-polar plate acts as both a negative terminal for one adjacent (e.g., above) membrane electrode assembly and a positive terminal for a second adjacent (e.g., below) membrane electrode assembly arranged on the opposite surface of the bi-polar plate.

In a PEM fuel cell, the hydrogen catalyst separates the hydrogen into protons and electrons. The ion conductive membrane blocks the electrons, and electrically isolates the chemical anode (hydrogen gas distribution layer and hydrogen catalyst) from the chemical cathode. The ion conductive membrane also selectively conducts positively charged ions. Electrically, the anode conducts electrons to a load (electrical energy is produced) or battery (energy is stored). Meanwhile, protons move through the ion conductive membrane. The protons and used electrons subsequently meet on the cathode side, and combine with oxygen to form water. The oxygen catalyst in the oxygen gas distribution layer facilitates this reaction. One common oxygen catalyst comprises platinum powder thinly coated onto a carbon paper or cloth. Many designs employ a rough and porous catalyst to increase surface area of the platinum exposed to the hydrogen and oxygen.

While the present invention has primarily been discussed so far with respect to PEM fuel cells in an RMFC, it is understood that the present invention may be practiced with other fuel cell types and architectures. One difference between fuel cell types is the ion conductive membrane used. In another embodiment, fuel cell 20 is phosphoric acid fuel cell that employs liquid phosphoric acid for ion exchange. Solid oxide fuel cells employ a hard, non-porous ceramic compound for ion exchange and may be suitable for use with the present invention. Generally, any fuel cell architecture may be used in a system and device of the present invention. Other such fuel cell architectures include alkaline, SOFC, solid-state phosphoric acid-based electrolyte fuel cell systems and molten carbonate fuel cells, for example.

In addition, cartridge 16 need not be smart. In other words, cartridge 16 may be a ‘dumb’ cartridge without a memory 106. This removes the need to include a controller 19 that communicates with memory 106.

### Cartridges

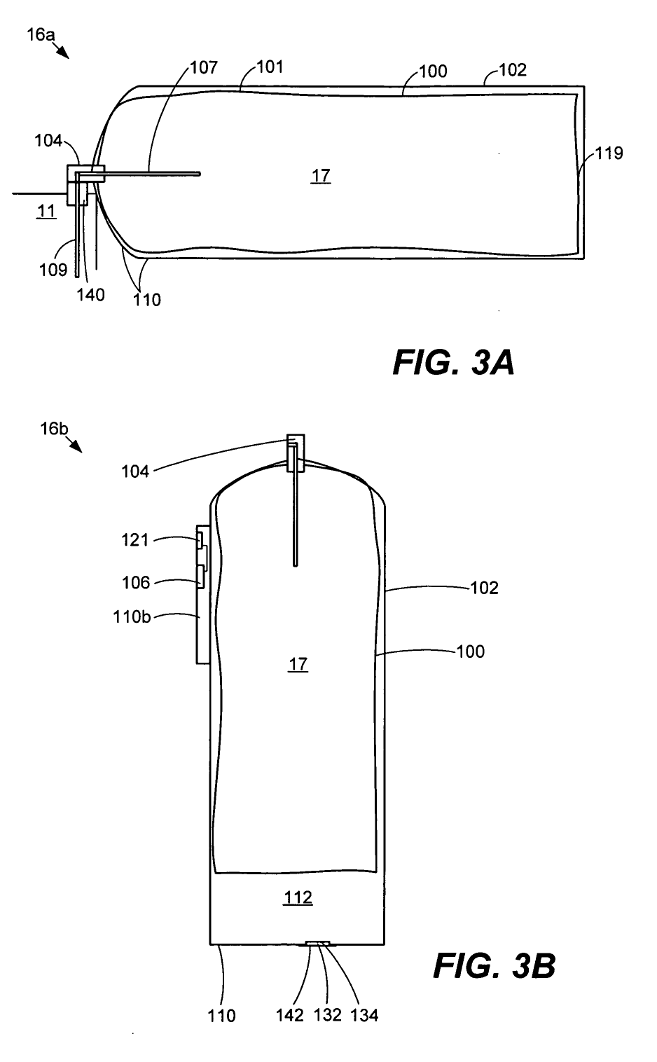

Having briefly discussed fuel cell systems fueled by a cartridge, exemplary cartridges suitable for distribution will now be discussed in more detail. FIG. 3A shows a simplified cross section of a cartridge 16a in accordance with one embodiment of the present invention. Cartridge 16a includes a bladder 100, housing 102 and connector 104.

Cartridge 16 stores fuel in a cavity internal to housing 102. In this instance, a bladder 100 contains fuel 17 and conforms to the volume of fuel in the bladder. In one embodiment, bladder 100 comprises a compliant structure that mechanically assumes a volume according to a volume of liquid stored therein. Compliant walls 101 of bladder 100, which stretch, expand and/or open when fluid is added to bladder 100, form the volume and contract and/or collapse fluid removal. In one embodiment, bladder 100 includes a sac that changes size and shape with the volume of liquid contained therein. A plastic, multi-layer sheet co-extruded, multi-layer sheet based material, rubber, latex or a metal such as nickel are suitable materials for use as walls 101 of bladder 100. In this case, walls 101 are compliant and change size with a changing liquid volume, and in some cases the walls allow for stretching with high fluid pressures in bladder 100. Walls 101 may also comprise a fire retardant plastic material. One suitable fire retardant plastic material for walls 101 is NFPA-701-99 Test 1 Polyethelyne as provided by Plasticare of Orange Park, Fla. In another embodiment, bladder 100 comprises a fixed cylinder and a piston that is pushed by a spring and moves in the cylinder to pressurize bladder 100 and displace volume according to used fuel.

A maximum volume 119 characterizes bladder 100 when the bladder fully expands. Maximum bladder volumes may vary with an application. In a specific embodiment, maximum volumes for cartridge 16a range from about 20 milliliters to about 4 liters. Maximum volumes from about 20 milliliters to about 800 milliliters are suitable for many portable electronics applications. A maximum volume for bladder 100 of about 80 to about 500 milliliters is suitable for laptop computer usage and numerous portable applications. A 200 cubic centimeter volume is suitable for some portable applications. Some extended run time systems may rely on storage devices 16a having up to 80 liters of maximum volume. The maximum volume for bladder 100 may differ from the fuel capacity of cartridge 16a. In some designs, cartridge 16a includes multiple bladders 100 that each contributes a maximum volume and cumulatively adds to a total fuel capacity for cartridge 16a. For example, a spare cartridge 16a intended for electronics power back up may contain two bladders 100 that each includes 300 milliliters of fuel 17.

While the present invention will now primarily refer to the storage of methanol in bladder 100 and cartridge 16a, it is understood that bladder 100 and cartridge 16a may contain other fuels such as those listed above. In addition, bladder 100 may contain a fuel mixture.

Housing 102 provides mechanical protection for bladder 100 and any other components of storage device 16a included within housing 102. Housing 102 comprises a set of rigid walls 110 that contain bladder 100 and other internal components of cartridge 16a. In one embodiment, all components of cartridge 16a are contained within housing 102 save any portions of connector 104 that protrude out of the housing for interface with mating connector 140. In another embodiment, connector 104 is recessed within housing 102 and housing 102 provides an outer shell or assembly housing that defines outer bounds and shape of storage device 16a. Walls 110 collectively form an outer case or shell that substantially mechanically separates components internal to housing 102 from the external environment. Walls 110 also collectively form an interior cavity 112 (FIG. 3B). Interior cavity 112 is a space within storage device that contains bladder 100. Housing 102 is referred to herein as a ‘housing assembly’ when one or more rigid walls or parts are added to cartridge 16a and provide additional functionality other than just containment of internal components. Such finctionality may include connectivity with a package, filtration of air going into a fuel cell system package, and holding one or more components of the cartridge such as a chip or an ambient atmospheric gas sensor that is configured to sense on or more gasses, such as CO, H₂ or O₂, for example.

Rigid walls 110 may comprise a suitably stiff material such as a plastic, metal (e.g., aluminum), polycarbonate, polypropelene, carbon fiber matrix, carbon composite material, etc. Rigid walls 110 may also be formed from a fire retardant material such as a fire retardant plastic material. One suitable fire retardant plastic material for walls 110 is 8-12% weight, JLS-MC mixed with PA66 Polyamide as provided by JLS Chemical of Pomona, Calif. Rigid walls 110 may be designed according to criteria for construction of thin walled pressure vessels. In this case, walls 110 and housing 102 may be designed to withstand a maximum pressure within bladder 100.

In one embodiment, housing 102 is integrally formed or manufactured to prevent disassembly of housing 102. In this case, walls 110 may be permanently attached (e.g., bonded and/or extruded from a common material) such that access into housing 102 is only gained through destruction of walls 110 and housing 102.

Connector 104 interfaces with a mating connector 140 included in device 11. Together, connector 104 and mating connector 140 permit transfer of fuel source 17 between bladder 100 and the external device 11. When mating connector 140 is included in a device that includes fuel processor 15 (see FIG. 2), connector 104 and mating connector 140 interface to permit transfer of fuel 17 from cartridge 16a to fuel processor 15, and through any intermediate plumbing between the two. Alternatively, when mating connector 140 is included in a hydrogen fuel source refiller, connector 104 and mating connector 140 interface to permit transfer of fuel 17 from the refiner to cartridge 16a. Interface between connector 104 and mating connector 140 may comprise any relationship and mating structures that permit fluid communication between the two connectors. In a specific embodiment, connector 104 includes a contact valve, which when depressed, permits fluid communication to and from bladder 100. In this case, connector 140 includes an o-ring or other suitable sealing and plumbing to interface with the contact valve and communicate fuel to or from cartridge 16a.

When mating connector 140 and connector 104 are mechanically coupled, a pump in device 11 and run by fuel cell system 10 draws fluid from bladder 100 into device 11. More specifically, fuel source 17 travels from bladder 100, through tube 107 and connector 104, into and through mating connector 140, and through tube 111 in device 11 to a fuel processor 15 included therein.

Cartridge 16a and device 11, and or connector 104 and mating connector 140, may also include mechanical coupling to secure the interface, such as sliding interfaces and latching elements that bind connector 104 and mating connector 140 together until physically released.

In another embodiment, cartridge 16/device 11 compatibility employs a connector compatibility between connector 104 including cartridge 16 and mating connector 140 included in device 11. The connector compatibility may include designated connector shapes intended for certain fuel types and/or device manufacturers, for example. In this case, mechanical connectivity and/or fuel transfer between cartridge 16 and device 11 is conditional upon the connection compatibility. This thwarts unintended cartridges 16 from interfacing with device 11, and (vice versa) thwarts unintended devices 11 from interfacing with cartridge 16. For example, some cartridges 16 may include a fuel such as NaBh_{4,} which should not be provided to a DMFC or RMFC the fuel cell system. The connection compatibility requirements may restrict the device 11/cartridge 16 relationship according to one or more of: fuel type (e.g., similar to unleaded gas/leaded gas nozzles at gas stations), fuel cell system type (RMFC, DMFC, etc.), cartridge 16 manufacturer, device 11 manufacturer (e.g., such as a certain set of laptop or electronics device manufacturers), fuel cell 20 manufacturer, fuel processor 15 manufacturer, date of manufacture, and/or fuel cell system generation, for example. Other restrictions are suitable for use with the present invention.

Connector compatibility may include a ‘keyed’ configuration that provides connection selectivity. For example, connector 104 may comprise a shape unique to a particular fuel (e.g., a circular adaptor for methanol). In this case, mating connector 140 offers an exclusive interface shape that only receives a connector 104 for a methanol based cartridge 16 with that shape. This keying system prevents the wrong fuel type from being installed in a device that cannot accept that fuel, e.g., gasoline burns at a higher temperature and may not be suitable for use in all methanol fuel processors. This keying system also prevents cartridge 16 from being refilled with the wrong hydrogen fuel source 17. Further description of connector compatibility is described in commonly owned and co-pending U.S. patent application Ser. No. 10/877,766, entitled “PORTABLE FUEL CARTRIDGE FOR FUEL CELLS”, which was incorporated by reference above. In addition, the present invention contemplates that adaptors may be used to have cartridges with incorrect connectors to be adapted to fit a certain keyed mating connector.

In another embodiment, cartridge 16/device 11 compatibility includes structural compatibility that requires the cartridge 16 housing to have a certain shape in order to physically interface with device 11. For example, device 11 may be a laptop computer and cartridge 16 is required to fit within a dc battery bay of the laptop computer. Alternatively, device 11 may include sliding and/or latching interfaces that require the cartridge to have mating sliding and/or latching interfaces in order to mechanically couple to device 11.

In one embodiment, one of connector 104 and mating connector 140 includes a ‘male’ designation and configuration while the other includes a ‘female’ designation and configuration. The male configuration includes portions of the connector that protrude, such as a valve, one or more pins or electrical leads. The female configuration includes portions of the connector that receive the male portions, such as receptacles that receive a contact valve, or holes arranged to receive the male electrical leads and permit electrical communication. The connector 104 on cartridge 16 may include a female configuration that recesses within housing 102. In this case, since it is recessed, connector 104 reduces the chances of being knocked off during handling.

Mating connector 140 may be disposed on a variety of devices. In one embodiment, mating connector 140 is disposed on a side portion of an OEM device (i.e. a laptop computer). In another embodiment, mating connector 140 is included in a portable fuel cell package. Further discussion of portable fuel cell packages suitable for use with the present invention are described in commonly owned patent application entitled “Compact Fuel Cell Package” and filed on May 2, 2005; this application is incorporated by reference in its entirety for all purposes. Mating connector 140 may also be included in a refilling device that includes hardware for refilling cartridge 16 with fuel source 17.

FIG. 3B illustrates a cartridge 16b in accordance with another embodiment of the present invention. Cartridge 16b includes several additional features that may be optionally included with storage devices of the present invention.

Cartridge 16b includes a memory 106, which stores information relevant to usage of cartridge 16b. Memory 106 may comprise a mechanical, electrical and/or digital mechanism for information storage. In one embodiment, memory 106 includes a mechanical device. One suitable mechanical device comprises ‘break-off’ pins that are altered each time cartridge 16b is used. Other forms of mechanical memory 106 may comprise discs or rods, which are removed or otherwise manipulated every time a storage device 16 is refilled. In another embodiment, memory 106 includes a visible identification tag that uniquely identifies cartridge 16. Various types of external identification tags are known in the art and may be used with this invention. Two examples of identification identifier tags include magnetic recording devices and optical bar codes. In this case, cartridge 16b includes an additional wall 110b affixed to the outside of housing 102 that holds and locates memory 106.

In one embodiment, memory 106 includes a digital memory source that permits a controller to read and write from the digital memory. In this case, cartridge 16b includes electrical connectivity 121 for digital communication between memory 106 and a processor or controller on device 11. For example, connector 104 may include female electrical slots 121. A mating connector 140 (FIG. 3A) for connector 104 then includes male leads positioned and sized to fit into slots 121. The electrical leads 121 contact when the connectors 104 and 140 interface and enable electrical and digital communication between a controller in device 11 and memory 106.

Memory 106 also stores information for authentication of cartridge 16b. This may include a public/private key encryption number, or another number suitable for CRC algorithms and other digital authentication techniques. A unique number assigned to cartridge 16b allows it to be exclusively identified. In one embodiment, the unique number is updated when cartridge 16b is refilled. A central database in communication with a refilling station then logs refilling information for cartridge 16b according to the unique number. The security and authentication information may also include an identification signature for cartridge 16b or the manufacturer of cartridge 16b. The authentication may restrict cartridge 16b usage to: a) designated electronics devices and portable fuel cell packages, b) designated fuel cell types, c) designated fuel cell system types, d) designated fuel cell and/or fuel cell system manufacturers, e) designated devices such as laptops or electronics devices common to a specific manufacturer, etc.

In one embodiment, cartridge 16b is considered ‘smart’ since memory 106 stores information related to the performance, status and abilities of cartridge 16b. A digital memory or chip allows a controller to read and write information relevant to usage of the cartridge 16b to memory 106. Reading from digital memory 106 allows reception and assessment of information in memory 106 to improve usage of cartridge 16b. For example, a computer that receives storage device 16 may inform a user that the storage device 16b is empty or how much fuel is left (or how much time on the system is available based on its power consumption and the amount of fuel remaining). Writing to a digital memory 106 allows information in memory 106 to be updated according to storage device 16 usage. Thus, if a user nearly depletes fuel 17 in cartridge 16b while powering a computer, the next user may be informed after the first computer writes an updated amount of fuel source 17 remaining in bladder 100 into memory 106.

Information stored in memory 106 that generally does not change with cartridge 16b usage and may comprise a) a fuel type stored in the cartridge 16b, b) a model number for cartridge 16b, c) manufacture date, and/or d) a volume capacity for bladder 100 or cartridge 16b. The model number of cartridge 16b allows it to be distinguished from a number of similar devices, and may also provide other logistical information to a controller such as an identity of the cartridge manufacturer.

Transient information stored in digital memory 106 that changes according to the status and usage of cartridge 16b may include a) a current volume for fuel in the storage device, b) a number of refills when cartridge 16b is configured for re-usable service, c) the last refill date, d) the refilling service provider that refilled cartridge 16b, e) usage history according to a storage device identification, and f) hydrogen fuel mixture information.

The compatibility information for cartridge 16b may be transient or fixed. For example, security features that protect the compatibility information may be updated each time the cartridge is refilled or used. Alternatively, the compatibility and/or authentication information may be fixed for the life of a cartridge.

Memory 106 may include any commercially available memory source, such as such as a non-volatile serial EEPROM memory chip. In a specific embodiment, memory 106 includes a model number bq26150 authentication chip as provided by Texas Instruments of Dallas, Tex. The bq26150 provides a method to authenticate fuel cartridges and information stored thereon as described below and ensures that only cartridges including predetermined compatibility information are used by a device that includes a fuel cell. The bq26150 uses a 96-bit unique device identification, a device unique 16-bit seed, and a 16-bit device specific CRC to provide cartridge authentication. In addition, the bq26150 stores other information such as an identification number for the cartridge, a CRC seed, and CRC polynomial coefficients. The information may also be stored with encryption to prevent open access to data.

The bq26150 also includes memory space to store information related to usage of the cartridge. For example, public OTP memory in the chip can be used as a fuel gauge. Each time that fuel is consumed, a fuel gauge in the memory is updated. In a specific embodiment, fuel is consumed in fixed increments and the memory uses a bit counter to track fuel usage. For example, fuel may be consumed at ‘x’ milliliter (e.g. 2 milliliter) increments and the memory moves to next bit each time the fuel increment is supplied. When ‘y’ bits have been incremented or programmed, x*y milliliters of fuel have been consumed. Known capacity for the cartridge then dictates when it is empty (e.g., a 200 ml is empty after 100 increments of 2 milliliters have been supplied). In a specific embodiment, when the cartridge is refilled, this chip is replaced when the memory includes a public OTP memory.

Cartridge 16b also includes one or more vents 132 in housing 102 that allow air to enter and exit in internal cavity 112 within housing 102 as bladder 100 changes in volume. Air vent 132 comprises one or more holes or apertures in a wall 110 of housing 102. In another embodiment, cartridge 16b does not include a vent in the cartridge housing 102 and relies on a vent included in a valve or connector 104 that provides fuel source communication into or out of the storage device.

A filter 134 spans the cross section of vent 132 and intercepts air passing through vent 132. In one embodiment, filter 134 comprises a hydrophobic and gas permeable filter that prevents foreign materials from entering cartridge 16b. Materials blocked by filter 134 may include liquids and particles such as undesirable oils and abrasives. The hydrophobic filter also prevents fuel 17 from escaping housing 102 in the event that bladder 100 develops a leak. Filter 134 may comprise micro porous Teflon or another micro porous material such as Teflon coated paper. A sintered metal filter, for example one with a 3 micron pore size, may also be used. One suitable filter 134 includes micro porous “Gore Tex”Teflon as provided by WL Gore Associates of Elkton, Md. A mechanical shield 142 spans and covers vent 132 and prevents foreign bodies from entering housing 102 through vent 132.

Cartridge 16b may also include other features such as a pressure relief valve that limits pressure in the bladder 6r cartridge, a fuel filter that intercepts fuel 17 as it leaves bladder 100 and before it leaves connector 104, a fire retardant foam disposed in bladder 100, and a wireless identification (ID) tag for memory 106, for example. These and other features suitable for use with a cartridge of the present invention are described in commonly owned and co-pending U.S. patent application Ser. No. 10/877,766 and entitled “PORTABLE FUEL CARTRIDGE FOR FUEL CELLS”, which was incorporated by reference above.

The present invention also improves mechanical interface between a cartridge and a device that couples to the cartridge to receive fuel. The interface may include one or more of: a sliding interface between a cartridge and package, a latching interface that holds the cartridge in one or more positions relative to the package, and/or security features that prevent unintended detachment or attachment, for example.

Cartridges of the present invention may include one or more commercially available components. Using commercially available products allows the present invention to use mass produced, readily available, and proven technology. Off-the-shelf components may also reduce cartridge cost.

Aerosol cans, for example, are a proven technology suitable for use with housing 102 to store a hydrogen bearing fuel. Conventional aerosol containers are well suited for high-pressure capabilities, such as 200 psig and above. Conventional aerosol containers also include relatively high evacuation efficiency and may rely on commercially automated fueling equipment or fueling equipment and methods as described below. Other commercially available components suitable for use in a hydrogen fuel cartridge (housing 102 and other components) include those used in the shaving industry, those use in portable lighters, and those used for pressurized air delivery (e.g., to power a nail gun). These devices often include commercially available components suitable for use in a cartridge such as: commercially available cartridge housings (also referred to as ‘canisters’ or ‘cans’), bladders, commercially available heads (or ‘mounting caps’) that attach to the canisters, nozzles, and so on. Many commercially available nozzles include contact valves that permit binary fluid communication with/without contact. One suitable supplier of aerosol products including canisters and contact nozzles is Precision Valve, Inc. of Yonkers, N.Y.

Many such commercially available devices permit storage of liquids and fuels at high pressures. Some commercially available storage devices are capable of handling pressures up to and above 200 psi. Stronger commercially available storage devices handle pressures up to about 500 or 600 psi. Using commercially available high-pressure components for the storage device also permits the present invention to use proven technology in a relatively new field.

In a specific embodiment, the cartridge housing includes commercially available aluminum components that crimp and seal together. For example, the housing may include a top aluminum head portion (also referred to as a ‘mounting cup’) that crimps to a cylindrical aluminum housing (also referred to as a ‘can’). This advantageously seals the head to the cartridge housing. One or more components may be added internally to the aluminum cartridge housing before the seal is made. For example, a bladder may be added before the two parts are joined. The crimped connection then secures and seals the bladder.

In a specific embodiment, a cartridge comprises one or more of the following materials: polycarbonate, ABS, PET, HDPE, or PCABS in a housing; steel or aluminum or another suitably rigid metal or material for in a housing; tinplate/polypropylene/nylon for a valve; and nylon or polypropylene for a bladder. Other materials may be used. The fuel cartridge may also include a commercially available 202 bag accessed using a commercially available aerosol valve. One of skill in the art is aware of the wide range of the aerosol can designs, bags and valves, and the fuel cartridge is not limited to any particular cartridge construction or design.

### Compatibility

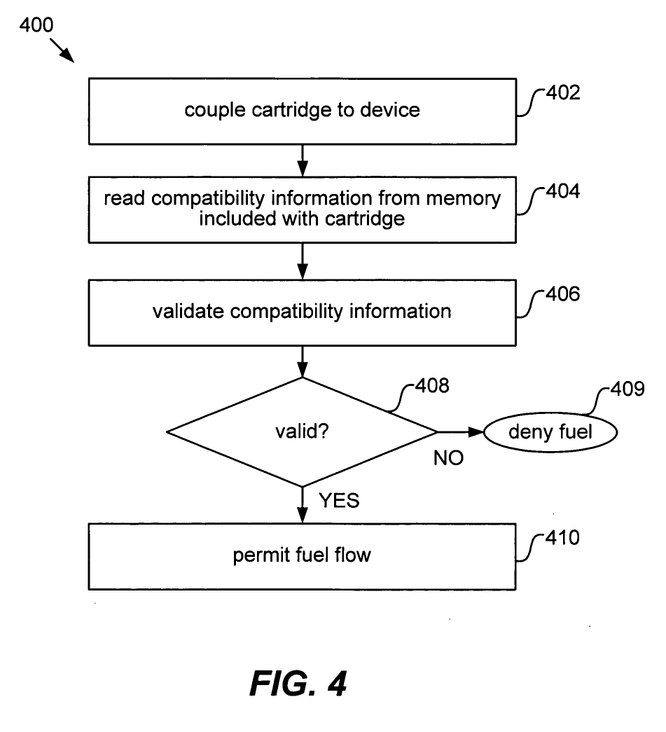

The present invention also improves compatibility management between fuel cartridges and devices. FIG. 4 shows a method 400 for validating fuel provision from a cartridge that stores a fuel in accordance with one embodiment of present invention.

Method 400 begins with receiving a cartridge at a device that includes a fuel cell or fuel cell system (402). The device may include a sensor that detects when the cartridge has been mechanically coupled to the device and provides sensor feedback indicates when a cartridge has been coupled. Alternatively, electrical contacts may provide a digital signal informing the device controller of cartridge presence.

A controller in the device then reads compatibility information from a memory included with the cartridge (404). The read steps will depend on the cartridge memory type. In a specific embodiment, the device employs an optical reader to read optical compatibility information stored in a 1-D or 2-D barcode attached to or printed on the cartridge. The optical reader then converts the optical information into digital information. For a digital memory included in the cartridge, the controller accesses the memory using the appropriate digital memory read commands.

In one embodiment, an encryption scheme protects the compatibility information, e.g., when it is stored on a chip or in optical memory. For example, cartridges intended for use with laptop computers may include a public/private key encryption system to avoid open access to information on the chip. In this case, reading information from the cartridge memory also includes decrypting the encrypted information. The encryption protocol may include proprietary encryption techniques and/or publicly available and proven encryption methods.

Public-key encryption uses a combination of a private key that is known only to a first computer (or memory) and a public-key that is given to any other second computer or device that wants to a) communicate with the first computer, b) verify identity of the first computer, and/or c) verify information provided by the first computer. In a specific embodiment, a fuel cartridge memory includes an encrypted password or number that was encrypted using a public-key and a private key for the cartridge. The receiving computer uses the cartridge public-key (as provided by the fuel cartridge memory) and its own private key to decode the encrypted information stored on the cartridge. The decrypted information may then be used as validation of the cartridge.

In another embodiment, the cartridge has multiple memories such as a private memory and a public memory. In a specific handshake embodiment, the cartridge has a private key that is a) stored unencrypted in the cartridge private memory and b) stored encrypted by a public key in its public memory. A host controller reads the public memory and decrypts encrypted private key using the public key, generates a random challenge, and sends the challenge to the cartridge. In response, the cartridge generates a CRC using its private key and sends the CRC to the host. The host verifies the CRC using its copy of the decrypted cartridge private key. If the CRCs agree, then the cartridge is authenticated. Other handshakes between a host controller and cartridge are also suitable for use herein.

Compatibility information included on the cartridge is then validated before permitting fuel provision from the cartridge to the device (406). Validation may include any logic and/or validation algorithms suitable for resolving a) which cartridges may provide fuel to the device and/or b) which cartridges are unauthorized or otherwise precluded from providing fuel to the device. In one embodiment, cartridges that do not include compatibility information are not validated and permitted to provide fuel to the device.

The present invention may use a wide variety of validation and cartridge authentication techniques. In one embodiment, the present invention employs a customized authentication handshake between the device and cartridge. For example, a manufacturer may devise a custom authentication routine to validate compatibility of a cartridge before drawing fuel. In another embodiment, the compatibility information includes a customized and known number or password to be verified by the device. The password may be further protected and authenticated using a digital signature or digital certificate created via a private key for the fuel cartridge. The digital certificate permits any device to confirm identity of the fuel cartridge—and that the cartridge is compatible with the device.

Established authentication methods are also suitable for use. In one embodiment, a publicly available encryption protocol is employed to authenticate a fuel cartridge. For example, the cartridge may include a number encrypted with a proven encryption technology. The controller then decrypts and validates the number before it permits fuel flow from the cartridge. Established authentication techniques suitable for use with the present invention include public/private key encryption, CRC algorithms etc. Other encryption and authentication techniques are also suitable for use herein. In this case, a device controller implements the authentication scheme using instructions stored in a memory for the device.

Compatibility information decrypted and authenticated in this manner may include a number for the cartridge, a fuel type on the cartridge that is suitable for use with the device, a fuel mixture that the cartridge stores that is suitable for use with the device, code for the refilling location, number refills of the cartridge, unique cartridge serial number manufacture date, maximum allowable fuel level, and/or current fuel level. Other information may also be used for encrypted authentication.

In another embodiment, the device applies logic as to whether the cartridge is suitable to provide fuel to the device. For example, the device may limit cartridge compatibility according to fuel type or fuel mixture. As determined from the compatibility information, cartridges not having the correct fuel type are then prevented from providing fuel to the device.

Different devices may use separate authentication techniques in order to provide selective compatibility between devices. For example, validation intended for use with laptop computers may include a public/private key encryption system, while cartridges intended for use with portable fuel cell package is used by the military may include a CRC algorithm authentication. In this case, a controller in a laptop computer is configured to perform public/private key authentication. The military cartridge, which may only include CRC algorithm authentication information, would not pass validation with this laptop since it does not include the public/private key authentication information that the laptop looks for and needs to satisfy its validation requirements.

Method 400 then permits fuel to flow from the cartridge to the device when the compatibility information is valid (410). Enabling fuel provision will depend on the fuel cell system, as one of skill in the art will appreciate. In one embodiment, a pump moves the fuel from the cartridge to the device, and successful validation of the compatibility information triggers the controller to instruct the pump to begin fuel provision from the cartridge to the device. In another embodiment, the cartridge includes a pressurized source internal to the cartridge and the device controller operates a valve that regulates fuel flow from the cartridge to the device. In this case, permitting the fuel to flow includes opening the valve to provide a desired fuel flow rate. Alternatively, when the compatibility information is not valid, or absent from the cartridge, method 400 denies fuel to flow from the cartridge to the device. The device may then communicate incompatibility to the user. A laptop computer for example may provide video and or audio cues, for example, to indicate an unsuccessful validation attempt.

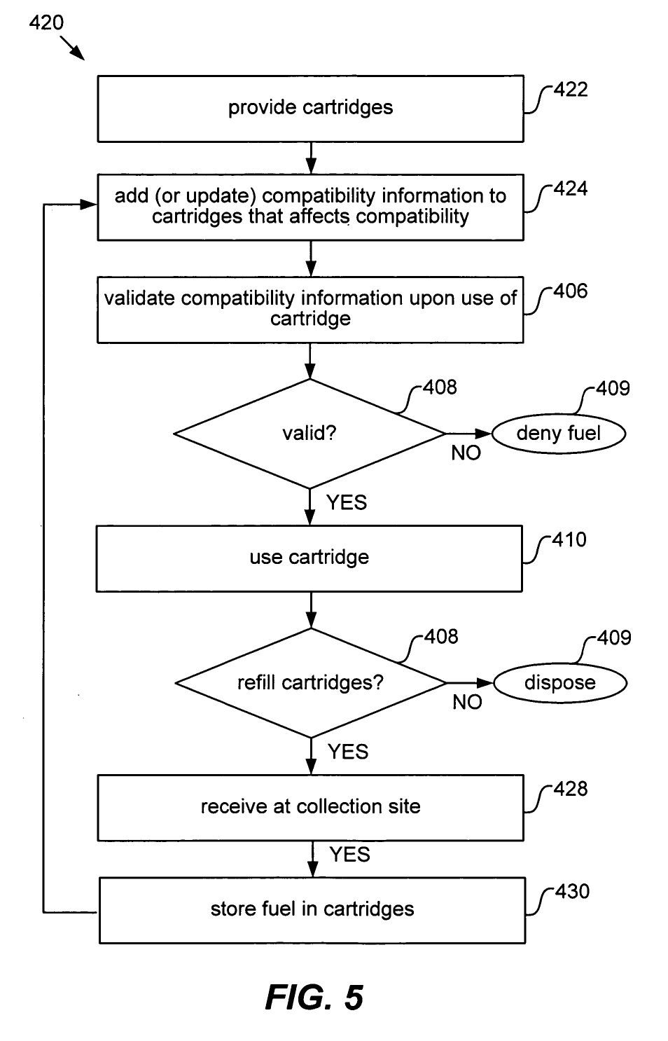

Validation of cartridge compatibility according to the present invention also improves cartridge distribution. FIG. 5 shows a method for cartridge distribution 420 that applies cartridge/device validation in accordance with one embodiment of present invention.

Cartridge distribution 420 begins with providing cartridges (422). This may be done by an initial manufacturer of hardware for the cartridges (86 in FIG. 1), a cartridge fuel supplier that stores fuel into the cartridges (82 in FIG. 1A), and/or a sales entity that distributes or sells cartridges to consumers. Direct sales may include sales at retail outlets and mail order, for example. Indirect sales may include cartridge production at an OEM that supplies cartridges to an electronics device manufacturer, for example, that does not make its own cartridges but sells fuel cartridges for use with their electronics devices.

One of these entities adds compatibility information to a cartridge that affects compatibility between fuel cartridges and devices that include a fuel cell and use a fuel cartridge (424). The compatibility information reduces compatibility of a cartridge by restricting what devices the cartridge will provide fuel to and/or restricting what cartridges can provide fuel to a device.

Cartridge distribution according to the present invention thus permits flexible and customizable compatibility arrangements. Exclusivity may be established for cartridges and/or devices. Cartridge exclusivity limits which cartridges a device receives fuel from; device exclusivity restricts which devices a cartridge may provide fuel to.

In one embodiment, a device manufacturer uses cartridge exclusivity via validation of compatibility information to limit what cartridges their device will accept fuel from. This permits the device manufacturer to invalidate cartridges according to fuel type, for example. Fuel cell systems are often designed to receive a single or limited set of fuels; a methanol fuel cell system (RMFC or DMFC) typically is not intended to receive an ammonia fuel for example. In addition, an RMFC or DMFC fuel cell system may require a particular fuel mixture. In instances such as these, authenticating cartridge compatibility protects the fuel cell system from receiving a fuel it was not intended to receive (e.g., in the event that someone succeeds in using a cartridge that supplies an incorrect fuel for the fuel cell or system).

Cartridge validation and exclusivity may also be selective amongst cartridge manufacturers. One specific distribution arrangement dispenses cartridges with compatibility information that is local to one or more laptop (or other electronics device) manufacturers. In this case, devices of a particular manufacturer check for compatibility information included in approved cartridges to selectively authenticate which cartridges their devices use. This provides cartridge selectivity between cartridges that otherwise may be compatible (e.g., cartridges that include compatible features such as a suitable connector and fuel type). Selective authentication in this manner permits a device manufacturer to influence who supplies cartridges for their devices. The manufacturer then provides the compatibility and authentication information to cartridge manufacturers and distributors it approves, e.g., to ensure cartridge quality for its customers. Thus, the selective authentication permits one cartridge supplier or manufacturer to provide cartridges for that device/manufacturer, while a second cartridge manufacturer, which would otherwise provide compatible cartridges, is denied from supplying compatible cartridges for that manufacturer. In addition, this enables distribution selectivity to certain cartridge manufacturers and suppliers, while maintaining standardization of cartridges to all electronics devices in a field based on other common features (such as fuel type and connector).

Cartridge compatibility and selectivity may be divided by: device type (laptop, cell phone, PDA, portable fuel cell system, etc.), fuel type, device manufacturer, fuel cell type (RMFC, DMFC, SOFC, etc.), fuel cell system type (RMFC, DMFC, SOFC, etc.), business desire such as relationships with quality partners, geographic region such as country, max fuel level, and/or current fuel level and application (i.e. Mil Spec or IEC certification).

Authentication and compatibility also permits cartridge manufacturers in distribution arrangements to control which and whose devices their cartridges operate with. In one embodiment, the cartridge includes a small processor or that requires authentication with the device. In this case, compatibility information is selectively provided to one manufacturer and an electronics device (e.g., laptop computers and Apple), while a second electronics device manufacturer (e.g., laptop computers and Toshiba) is denied form using the cartridges based on its exclusion from the compatibility information (e.g., an encrypted number that selectively enables compatibility but is only known by one manufacturer). This selectivity may occur even though both cartridges include otherwise compatible features such as a connector common to all laptops or a fuel common to all laptops.

Cartridge compatibility may also be dissected based on device. More specifically, only certain devices may be used with cartridges that dictate what devices they provide fuel to. For example, methanol cartridges for laptop computers may include compatibility information that methanol cartridges for cell phones and PDAs do not include.

A digital memory on a cartridge may also specify compatibility options. Instructions stored in the cartridge memory may dictate what devices are suitable for use with the cartridge. For example, the cartridge may include a certain fuel type and the memory informs a probing controller what type of fuel the cartridge contains. The controller then validates if this type of fuel is suitable for use with its device. In another embodiment, the memory includes a list of devices such as laptop computers that the cartridge is permitted to provide fuel to. This is useful when a laptop manufacturer for example includes an older version and a newer version of a fuel cell system in the laptop and the versions require different fuels. The cartridge may then specify which laptop models it is compatible with.

Returning to FIG. 5, compatibility information included on the cartridges is then validated (406). If the authentication does not pass, then the controller on the device denies fuel provision from the cartridge (409). Denial may include not turning on a pump or opening a valve that enables fuel flow from the cartridge to the fuel cell system. If the authentication passes, then the controller permits fuel flow and cartridge usage (410).

The cartridges may be disposable or reusable. Disposable cartridges are discarded when depleted. Refillable cartridges may also be disposed if desired, or brought to a collection site (428). The collection site may locally store fuel in the cartridges, or ship them to another facility for refilling (430).

At this point, compatibility information the cartridges may be updated (back to 424). For example, encrypted numbers and passwords may be changed. Alternatively, a new digital chip may be inserted in place an old chip when the cartridge is refilled. Digital authentication chips that cannot be reprogrammed will be replaced with a new chip. Disposal of the used chip may offer cost reduction opportunities for a new cartridge. In some instances, single use chips are more cost effective that re-writable chips, and the interface between the cartridge and fuel cell system can be simplified.

### Fuel Storage

The present also improves distribution by improving fuel storage—both initially and during refilling. The refilling methods in particular permit more flexible cartridge distribution environments.

Maintaining consistent fuel supply into a fuel cell system leads to stable operation and electrical output. Most reformers and burners in a portable RMFC system benefit from consistent fuel provision. Fuel flow rates for portable fuel cell systems in general are typically low and the delivery plumbing often includes a small lumen. Small vapor or gas bubbles in the fuel delivery lines that proceed from the cartridge into the fuel cell system may cause a dropout in fuel cell power output. These dropouts, due to momentarily starving a fuel processor or fuel cell, may be as short as a few seconds or as long as a few minutes—depending on the size of the bubble or the power output level of the fuel cell.

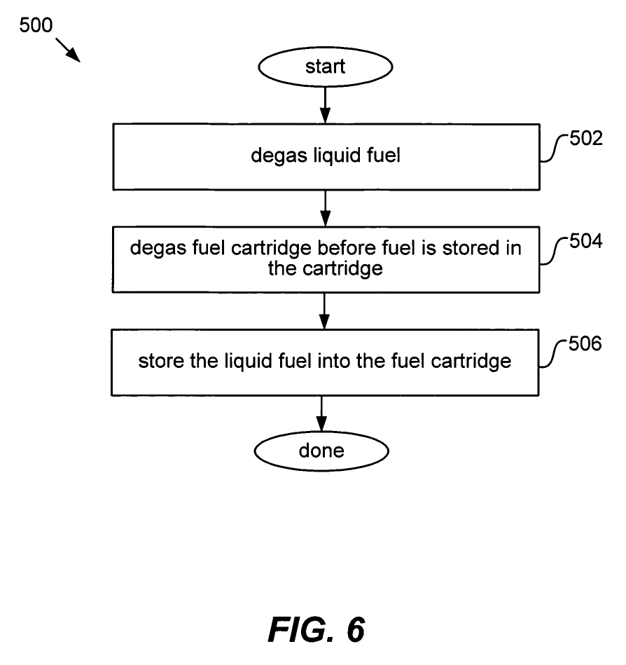

In one embodiment, the present invention minimizes the presence of gas bubbles in the fuel included in a cartridge. This is done when the fuel is stored in the cartridge—either initially or during a re-filling. FIG. 6 shows a process flow 500 for storing fuel in a portable fuel cartridge in accordance with one embodiment of the present invention.

Process flow 500 begins by at least partially removing one or more dissolved gases from the liquid fuel (502). In one embodiment, the gases are removed from a liquid fuel by vacuuming with a vacuum device such as a pump or a syringe that lowers pressure in the fuel. This may be done prior to blending the fuel with water or other fuel blend constituents, or after blending to form a blended fuel mixture. The vacuuming and duration of pressure reduction will vary based on the particular fuel being degassed as well as a desired threshold for gas concentration in the fuel. The fuel may also be agitated during this time to expedite and increase gas escape. For less than 200 cubic centimeters of methanol, lowering the pressure from about 14.7 PSIA to about 6 PSIA for about 30 seconds to about 1 minute at room temperature (˜25 degrees Celsius) while agitating the liquid is sufficient to substantially degas the fuel. Alternatively, a commercial HPLC (high performance liquid chromatography) solvent degasser may be used to degas the methanol. For example, a Rheodyne LLC Systec (of Rohnert Park, Calif.) degas system is suitable for use in this regard.

In another embodiment, degassed occurs by boiling. Again, this may be done prior to blending each of the constituent fuel liquids (e.g., methanol, water, etc.) or after blending. The boiling temperature and duration will depend on the particular liquid being boiled and a desired threshold for gas concentration the fuel, as one of skill in the art will appreciate. For 200 cubic centimeters of methanol, boiling the methanol at about 70 degrees Celsius for about 5 minutes and boiling the water at about 105 degrees Celsius for about 5 minutes prior to blending may sufficiently degas a fuel mixture. Other durations and temperatures may be used.

In another embodiment, degassing occurs by sparging. Sparging refers to the process of introducing a gas into a liquid to remove another gas from the liquid. Helium and hydrogen are suitable for use for methanol sparging. In a specific embodiment, helium is sparged through the fuel and water (or other fuel constituents) for about 5 minutes prior to blending. Other gases and times are also suitable for use.

In one embodiment, a manufacturer may employ a gas sensor to assess fuel-degassing efficacy for any of these degassing techniques. For example, a Hach HQ10 biological oxygen detector is suitable to detect oxygen in the fuel. Detection and characterization of the concentration of other dissolved gases such as nitrogen, carbon dioxide, or noble gasses may also be useful for process control.

Process flow 500 then at least partially removes one or more gases from a volume in the fuel cartridge that stores the fuel before fuel is stored in the cartridge (504). This removes gases that are inside an assembled yet unfilled fuel cartridge. In one embodiment, a commercially available vacuum pump withdraws gases from the cartridge, such as a VWR vacuum pump. The pump applies a vacuum pressure until a desired internal pressure is achieved. In one embodiment, reducing the internal pressure of the cartridge to between about 5 to about 12 PSIA is sufficient. In a specific embodiment, reducing the internal pressure to between about between about 8 to about 9 PSIA works for portable methanol cartridges. The vacuum pressure is applied for a duration sufficient to attain the gas concentration. In one embodiment, vacuum pressure is applied into the cartridge from about 2 seconds to about 60 seconds. In a specific embodiment, vacuum pressure is applied to the cartridge for about 30 seconds.

After the fuel and the cartridge have been degassed, process flow 500 then primes delivery plumbing between the fluid valve and internal bladder volume plumbing by filling the plumbing with fuel. The plumbing may include the fuel valve, a stem between the fuel valve and bladder, etc. This prevents air or other gases from re-entering through the valve during fuel deposition.

Process flow 500 then stores the liquid fuel into the fuel cartridge (506). This is accomplished, for example, using a pump that moves the fuel from a fuel filling or re-filling reservoir.

Storing the degassed fuel in the cartridge as soon as possible after degassing the fuel and cartridge reduces atmospheric gas accumulation in the fuel. In one embodiment, a lean flow line is established so that the appropriate amount of fuel is degassed (185 mL for example) and immediately injected into a single cartridge that has just been evacuated. A manufacturing assembly line may be arranged such that fuel insertion quickly follows cartridge evacuation.

After the fuel cartridge fills to a desired volume, it may be beneficial to apply a vacuum of approximately 12 PSIA to remove any gas that accumulated at the top of the canister during the filling operation.

Once the degassed fuel has been stored in the degassed cartridge, it is desirable to prevent the inside of the cartridge from picking up atmospheric gas or other sources of gas. Cartridges described herein accomplish this by using cartridge plumbing and cartridge materials with sufficiently low gas permeability that prevents atmospheric sources of gases from entering the fuel through the walls or connectors of delivery line. For example, NO-OX tubing and connectors as provided by Kontes Glass Company of Vineland, N.J. are suitable for use. In addition, a multi layer heat sealable packaging material such as OPP metalized film as provided by Toray Plastics of North Kingstown, R.I. is suitable to improve sealing and air penetration. In addition, a valve may be selected to prevent leakage of atmospheric gases into the cartridge during storage. A 49000965-Valve as provided by Precision Valve of Ajax, Ontario Canada may be used.

In another embodiment, the cartridge is packaged with a positive pressure that prevents atmospheric gas from entering. The may be accomplished by injecting enough extra fuel into the cartridge to raise the internal pressure to approximately 15 PSIA. Other internal positive pressures may also be used.

Storage devices of the present invention may also be configured for refillable usage. Thus, process flow 500 may be implemented during an initial fill of a cartridge, and during a subsequent refill. FIG. 7 illustrates a system 160 for providing a refillable fuel cartridge 16 in accordance with one embodiment of the present invention. System 160 comprises cartridge 16 and a hydrogen fuel refiner 162.

Refiller 160 includes mating connector 140 and is configured to provide fuel 17 to cartridge 16 when connector 104 is coupled to mating connector 140. Connector 104 and mating connector 140 interface to permit transfer of fuel 17 from refiner 160 to cartridge 16. Refiller 160 comprises a fuel reserve tank 164 that stores fuel 17. Tank is suitably size to refuel numerous cartridges 16. A pump 166 receives control signals from a refiner controller 168 that controls functioning of refiner 160 based on stored commands in refiller memory 170. Refiller memory 170 may also include a database that stores information for each cartridge 16 serviced by refiner 160.

A line 172 transports fuel 17 from tank 164 to cartridge 16. More specifically, pump 166 moves fuel 17 from tank 164 through tube 109 in mating connector 140, into and through tube 107 in connector 104, and into an internal volume 180 in cartridge 16 for storage therein. Although refiner 160 is shown refilling a single cartridge 16, it is understood that refiner 160 may comprise multiple ‘bays’ that each include a mating connector 140 and plumbing to refill a single cartridge 16. Refiller 160 may also include multiple tanks 164 that provided different fuel sources 17, such as different fuel sources (e.g., methanol or ethanol) or different fuel mixtures.

Controller 168 also communicates with memory 106 via line 174, which travels from controller 168, through electrical connectivity provided by connector 104 and mating connector 140 and to memory 106. Controller 168 may also communicate with memory 106 via wireless means when both controller 168 and memory 106 include such capability. Refiller 160 includes an interrogator 176 to communicate wirelessly with a cartridge 16. Interrogator 176 comprises a transceiver and antenna based on the communication frequency employed.

Controller 168 reads from, and writes to, memory 106. Controller 168 may read a usage history from a digital memory 106. Controller 168 may also check the status of any sensors on cartridge 16 used to monitor health of the device 16, such as an RDIF sensor that detects housing integrity. This helps a re-filling services provider determine if cartridge 16 can be simply be refilled, or if it needs to refurbished as well.

Controller 168 may also write into memory 106 information such as: the fuel mixture information stored therein, an updated number of refills provided to cartridge 16, a refill date, a refilling service provider, a volume for the cartridge, updated compatibility information, and updated security and authentication information.

Refillable system 160 allows distribution of fuel 17 to be handled flexibly. One approach is to distribute refillable cartridges 16 similar to the distribution of batteries. A consumer purchases a desired cartridge 16 at a retail outlet, such as a department store, super market, airport kiosk or drug store etc. Cartridge 16 selection may vary based on fuel 17 capacity, fuel 17 type or other features such as connectivity and smart features. Spent cartridges 16 may be dropped off at the any of the above locations for reuse, and shipped to a refilling services provider for refurbishment and refill.

Refilling system 160 allows a fuel 17 refilling provider to control refilling of cartridges 16 using compatibility information stored on the cartridge as described above. This also prevents unrestricted addition of fluids to cartridge 16. Refilling system 160 also provides a business model for distribution of cartridges 16. Refilling system 160 also permits a fuel 17 refilling provider to certify fuel blends, monitor the number of refills for a particular cartridge 16, and validate cartridge 16 for consumer or manufacturer confidence.

While this invention has been described in terms of several preferred embodiments, there are alterations, permutations, and equivalents that fall within the scope of this invention which have been omitted for brevity's sake. For example, while latching interface 200 was discussed with respect to two contact valves, the present invention may include only a single contact valve, such as one of those described above. It is understood that the present invention need not include one or more heat transfer appendages. It is therefore intended that the scope of the invention should be determined with reference to the appended claims.

What is claimed is:

1. In a device that includes a fuel cell, a method for validating fuel provision from a cartridge that stores a fuel, the method comprising:
reading compatibility information from a memory included with the cartridge;
validating the compatibility information before permitting fuel provision from the cartridge to the device; and
permitting fuel to flow from the cartridge to the device when the compatibility information is valid, or denying fuel to flow from the cartridge to the device when the compatibility information is not valid or absent.

2. The method of claim 1 wherein the memory includes a digital memory included with the cartridge.

3. The method of claim 2 wherein the compatibility information is encrypted in the cartridge memory.

4. The method of claim 3 further comprising decrypting the compatibility information.

5. The method of claim 1 further comprising receiving sensor feedback that indicates that the cartridge has been mechanically coupled to the device.

6. The method of claim 1 wherein permitting the fuel to flow includes opening a valve in the device that regulates fuel provision from the cartridge to the device.

7. The method of claim 1 wherein permitting the fuel to flow includes instructing a pump to move fuel from the cartridge to the device.

8. The method of claim 1 wherein the compatibility information includes an identification number.

9. The method of claim 8 wherein the identification number uniquely identifies the cartridge or corresponds to a manufacturer of the cartridge.

10. The method of claim 1 wherein the cartridge includes a compatible connector for the device, invalid compatibility information or absent compatibility information, and the fuel flow is denied.

11. The method of claim 1 wherein the cartridge includes a connector for the device fuel, invalid compatibility information or absent compatibility information, and the fuel flow is denied.

12. The method of claim 1 wherein the compatibility information includes information that prevents the cartridge from providing fuel to the device.

13. The method of claim 12 wherein the compatibility information includes a fuel type.

14. A device for receiving fuel from a cartridge that stores a fuel for use in a fuel cell system, the device comprising:
a fuel cell; and
a controller, operating according to instructions stored in a device memory, configured to communicate with a memory on the cartridge, obtain compatibility information from the cartridge memory, and validate the compatibility information before permitting fuel provision from the cartridge to the device.

15. The device of claim 14 wherein the controller is configured to deny fuel to flow from the cartridge to the device when the compatibility information is not valid or absent.

16. The device of claim 14 wherein the controller is configured to read from the cartridge memory.

17. The device of claim 14 wherein the controller is further configured to write to the memory.

18. The device of claim 14 wherein the controller writes an updated fuel capacity to the memory.

19. The device of claim 14 wherein the cartridge is external to the electronics device when providing the fuel.

20. The device of claim 14 wherein the memory includes a digital memory included with the cartridge.

21. The device of claim 20 wherein the compatibility information is encrypted in the cartridge memory.

22. The device of claim 14 wherein the compatibility information includes information that prevents the cartridge from providing fuel to the device.

23. The device of claim 22 wherein the compatibility information includes a fuel type.

24. The device of claim 14 wherein the compatibility information includes an identification number.

25. The device of claim 24 wherein the identification number uniquely identifies the cartridge or corresponds to a manufacturer of the cartridge.

26. The device of claim 14 further comprising a fuel processor.

27. A fuel cell system for producing electrical energy, the fuel cell system comprising:
a portable cartridge for storing a fuel, the cartridge including a memory that stores compatibility information, and a cartridge connector; and
a device that includes
a fuel cell,
a mating connector that interfaces with the cartridge connector to permit transfer of the fuel from the cartridge to the device, and
a controller, operating according to instructions stored in a device memory, configured to communicate with the cartridge memory, obtain compatibility information from the cartridge memory, and validate the compatibility information before permitting fuel provision from the cartridge to the device.

28. The system of claim 27 wherein the memory includes a digital memory included with the cartridge.

29. The system of claim 28 wherein the compatibility information is encrypted in the cartridge memory.

30. The system of claim 27 wherein the compatibility information includes an identification number.

31. The system of claim 30 wherein the identification number uniquely identifies the cartridge or corresponds to a manufacturer of the cartridge.

32. A portable cartridge for storing a fuel for provision to a device that includes a fuel cell, the portable cartridge comprising:
an internal cavity adapted to contain the fuel;
a cartridge connector for coupling to a mating connector on the device; and
a memory including compatibility information that enables a device to validate the compatibility information before permitting fuel provision from the cartridge to the device.

33. The cartridge of claim 32 wherein the memory includes a digital memory.

34. The cartridge of claim 33 wherein the compatibility information is encrypted in the cartridge memory.

35. The cartridge of claim 32 wherein the compatibility information includes information that precludes the cartridge from providing fuel to the device.

36. The cartridge of claim 32 wherein the internal cavity includes a bladder that contains the fuel.

37. A method of providing a plurality of cartridges for use with a device that includes a fuel cell, the method comprising:
storing a fuel in each of the plurality of cartridges;
adding compatibility information to a memory included in each of the plurality of cartridges, wherein the compatibility information enables the device to validate the compatibility information before permitting fuel provision from a cartridge coupled to the device; and
distributing the plurality of cartridges for sale to consumers.

38. The method of claim 37 wherein the memory includes a digital memory included with the cartridge.

39. The method of claim 38 wherein the compatibility information is encrypted in the cartridge memory.

40. The method of claim 37 wherein the compatibility information includes information that precludes the cartridge from providing fuel to the device.

41. The method of claim 37 wherein the compatibility information includes information that enables a controller in a device to permit fuel to flow from the cartridge.

42. The method of claim 37 wherein absence of the compatibility information prevents a device from permitting fuel to flow from the cartridge to the device.

43. The method of claim 37 wherein the compatibility information includes an identification number.

44. The method of claim 43 wherein the identification number corresponds to the cartridge or a manufacturer of the cartridge.

45. The method of claim 37 wherein the cartridge includes a compatible connector for the device and invalid compatibility information or a lack of compatibility information.

46. The method of claim 37 wherein the cartridge includes a connector for the device fuel and invalid compatibility information or a lack of compatibility information.

47. A method of storing a fuel in a fuel cartridge for use with a fuel cell system, the method comprising:
at least partially removing a gas from the liquid fuel;
at least partially removing a gas from a volume in the fuel cartridge that stores the fuel before fuel is stored in the cartridge; and
storing the liquid fuel in the volume.

48. The method of claim 47 wherein at least partially removing the gas from the volume in the fuel cartridge includes vacuuming the volume.

49. The method of claim 47 wherein at least partially removing the volume includes an internal volume of a compliant bladder included in the cartridge.

50. The method of claim 47 wherein storing the fuel occurs during a refill for the cartridge.

51. The method of claim 47 further comprising writing refill information to a memory in the cartridge.

52. The method of claim 47 wherein at least partially removing the gas from the liquid fuel includes vacuuming the fuel with a vacuum device that lowers pressure in the fuel.

53. The method of claim 52 wherein the vacuuming occurs before blending of the fuel with water.

54. The method of claim 47 wherein removing the gas from the liquid fuel includes boiling the fuel.

55. The method of claim 47 further comprising adding water to the liquid fuel before storing the liquid fuel in the cartridge.

56. The method of claim 47 further comprising detecting gas presence in a liquid fuel using a sensor.

57. The method of claim 56 wherein the sensor detects for oxygen in the fuel.

58. The method of claim 47 further comprising, after at least partially removing the gas from the volume, providing fuel into plumbing that leads from a valve for the cartridge to the volume with fuel.
